(19) United States
(12) Patent Application Publication
(10) Pub. No.: US 2026/0320579 A1
(43) Pub. Date: Oct. 15, 2026

(54) METHOD AND APPARATUS FOR MANAGING CONVERSION OF TRANSACTIONS TO BUY NOW, PAY LATER FINANCING

(71) Applicant: Affirm, Inc., San Francisco, CA (US)

(72) Inventors: Elizabeth CORBETT, San Francisco, CA (US); Laurie SELLICK, San Francisco, CA (US)

(21) Appl. No.: 19/643,977

(22) Filed: Apr. 10, 2026

Related U.S. Application Data
(60) Provisional application No. 63/786,621, filed on Apr. 10, 2025.

(51) Int. Cl. G06Q 20/24; G06Q 20/34

(52) U.S. Cl. CPC G06Q 20/24; G06Q 20/34

(57) ABSTRACT

A method of processing a customer transaction associated with a payment card may include determining a purchasing power associated with a user account of the customer, receiving an indication of a transaction between the customer and a vendor using the payment card, handling the transaction on behalf of the customer in response to the transaction being for an amount that is less than the purchasing power, updating the purchasing power based on the amount of the transaction, enabling the customer to provide an input to designate the transaction as a pay now transaction or an installment loan within a deferment period, and initiating a repayment path for a balance on the payment card in response to not receiving the input to designate the transaction as a pay now transaction by the deferment period.

### CROSS REFERENCE TO RELATED APPLICATIONS

This application claims priority to U.S. Provisional Patent Application No. 63/786,621 filed on Apr. 10, 2025, which is hereby incorporated by reference in its entirety.

### TECHNICAL FIELD

Example embodiments generally relate to financial industry technologies and, in particular, relate to apparatuses, systems, and methods for facilitating commerce and for enabling customers to selectively control settlement terms for financial transactions.

### BACKGROUND

The financial industry is comprised of many thousands of customers, vendors, lenders, borrowers, and other role players that all interact in various ways to enable customers to ultimately have access to goods and services provided by vendors. Credit and debit transactions have long been a way that individuals have managed point of sale transactions to ensure seamless transfer of funds from customers, or on their behalf, to vendors for relatively routine or small transactions. Meanwhile, obtaining a loan from a bank has long been the most common way of obtaining financing for non-routine or larger transactions.

Credit cards and certain other lending vehicles may be useful tools for many customers. However, some customers can find themselves over extended either quickly or over a period of time based on the existing tools. This phenomenon has repeated itself over generations, and for millions of customers. Thus, there is now a deep desire on the part of many to create flexible and fair means of supporting customer purchasing activities.

### BRIEF SUMMARY OF SOME EXAMPLES

Accordingly, some example embodiments may enable the provision of technical means by which to give customers decision-making power over how transactions or a monthly balance on their payment card should be treated. Such power may enable customers to have access to a payment card (virtual or physical) with a dynamic purchasing power capacity along with buy now, pay later functionality.

In an example embodiment, a method of processing a customer transaction associated with a payment card may be provided. The method may include determining a purchasing power associated with a user account of the customer, receiving an indication of a transaction between the customer and a vendor using the payment card, handling the transaction on behalf of the customer in response to the transaction being for an amount that is less than the purchasing power, updating the purchasing power based on the amount of the transaction, enabling the customer to provide an input to designate the transaction as a pay now transaction or an installment loan within a deferment period, and initiating a repayment path for a balance on the payment card in response to not receiving the input to designate the transaction as a pay now transaction by the deferment period.

In another example embodiment, an apparatus for processing a customer transaction associated with a payment card may include processing circuitry configured to perform a method. The method may include determining a purchasing power associated with a user account of the customer, receiving an indication of a transaction between the customer and a vendor using the payment card, handling the transaction on behalf of the customer in response to the transaction being for an amount that is less than the purchasing power, updating the purchasing power based on the amount of the transaction, enabling the customer to provide an input to designate the transaction as a pay now transaction or an installment loan within a deferment period, and initiating a repayment path for a balance on the payment card in response to not receiving the input to designate the transaction as a pay now transaction by the deferment period.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for providing a selective financing and payment platform according to an example embodiment;

FIG. 2 illustrates a functional block diagram of an apparatus for defining a facilitation agent according to an example embodiment;

FIG. 3 illustrates a block diagram showing control flow for account setup in accordance with an example embodiment;

FIG. 4 illustrates a block diagram for control flow associated with initial transaction handling in accordance with an example embodiment;

FIG. 5 illustrates a block diagram of control flow for intermediate handling and settlement of the transaction in accordance with an example embodiment;

FIG. 6 is a block diagram showing how funds flow between parties in accordance with an example embodiment;

FIG. 7 illustrates a method for managing a customer transaction in accordance with an example embodiment;

FIG. 8 illustrates an example control console or application interface that may be used to convert transactions between pay now and installment loan processing in accordance with an example embodiment; and

FIG. 9 is an example control console or application interface for checking or changing terms of the installment loan in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide for a data processing platform that can be instantiated at an apparatus comprising configurable processing circuitry. The processing circuitry may be configured to execute various processing functions on financial data using the techniques described herein. The data processing platform may, for example, be configured to provide an information exchange via which multiple independent or even proprietary platforms may be connected to each other. As such, the data processing platform may be embodied as a selective financing and payment platform (i.e., SFP platform) that connects customers and merchants (or vendors) to banks, payment services, and a transaction facilitator within the financial industry. By enabling data between the players on or members of the platform to be shared, and by further providing customers with tools for using the platform to manage their purchasing power within a given period of time, customers may have increased flexibility for managing their funds, while still maximizing their access to the goods and services they desire or need at any given time. Moreover, the platform may be employed under the management of the facilitator to control the usage of data on mutually agreeable terms for all participants who access the platform. Accordingly, a commercial framework can be provided by a technical platform designed to connect customers with access to financial support to effect transactions in real time while having the optionality to convert to an installment loan (e.g., a buy now, pay later (BNPL) loan). In other words, instead of merely initiating a platform for supporting buy now, pay later transactions, example embodiments provide customers with technical means by which to buy now, and decide how to pay (either now or later). The creation of one platform, managed by the facilitator, for the interaction of multiple parties to enable determination of how a transaction will be settled and how any resulting monthly balance will be handled provides a flexible and yet cohesive experience for customers that maximizes responsible access to financial freedom and satisfaction.

Within this context, a transaction is considered “settled” when all parties involved in the transaction have received any payments or funds that may be owed to them. Thus, if cash is paid to the vendor by the customer, the transaction is immediately settled. For a credit card purchase, the transaction may be settled when the vendor has received funds from the financial institution associated with the credit card. Example embodiments may allow a transaction to proceed as if a normal purchase or credit card as far as the vendor is concerned. In this regard, the customer may present a physical or virtual card for payment of goods and services at a vendor or merchant. The customer may decide to convert the monthly balance of the card to an installment loan, or in some cases, may change the nature of an individual transaction to an installment loan (e.g., a buy now, pay later loan). In this context, an installment loan has a fixed payment amount and term for making such payments. In other words, the installment loan does not have a conventional interest rate that applies over whatever indeterminate period of time the customer chooses to keep the loan by not paying off the entire principal.

Example embodiments not only provide the SFP platform, but also provide various enabling technologies that may facilitate operation of the SFP platform itself or of modules that may interact with the SFP platform. Example embodiments may also provide for enhancement of functionalities associated with the environment that is created by the SFP platform. The SFP platform may provide a mechanism by which to enhance commerce in a responsible way that is both empathetic and empowering to customers.

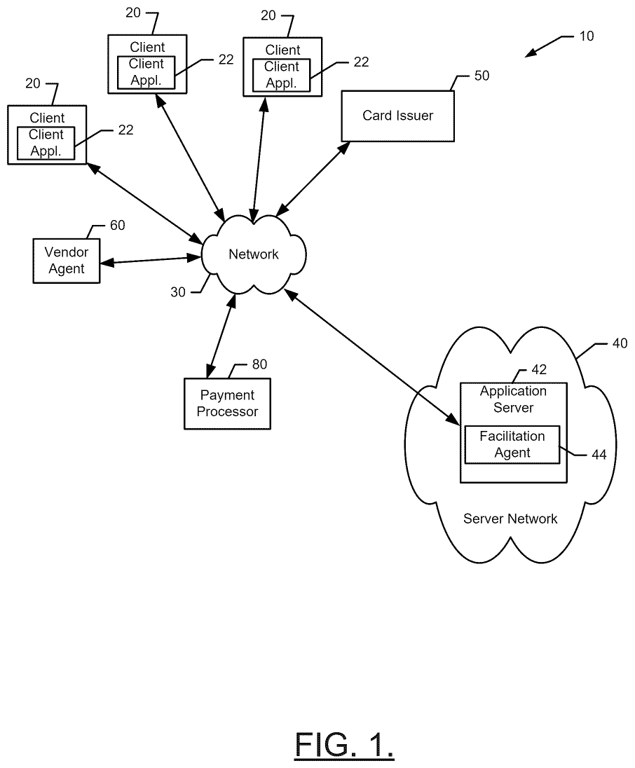

An example embodiment of the invention will now be described in reference to FIG. 1, which illustrates an example system in which an embodiment of the present invention may be employed. As shown in FIG. 1, a system comprising an SFP platform 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The clients 20 may, in some cases, each be associated with a single individual or customer. However, in some embodiments, one or more of the clients 20 may be associated with an organization (e.g., a company) or group of individuals (e.g., a family unit). In general, the clients 20 may be referred to as members of the environment or community associated with the SFP platform 10.

Each one of the clients 20 may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to the SFP platform 10, and more particularly relating to facilitating transactions where the details of setting the transaction will be determined after the transaction. For example, the application server 40 may be configured to provide for storage of information descriptive of events or activities associated with the SFP platform 10 and the execution of a financial transaction on behalf of a customer in real time. In some cases, data and/or services may be exchanged amongst members, where specific needs or desires of the members are aligned with respect to playing their respective roles in connection with conducting a financial transaction, and enabling card balance and settlement method for the transaction to be determined or changed at certain predetermined times.

In some embodiments, for example, the application server 40 may therefore include an instance of a facilitation agent 44 comprising stored instructions for handling activities associated with practicing example embodiments as described herein. The facilitation agent 44 may be a technical device, component or module affiliated with the facilitator of the functioning of the SFP platform 10. Thus, the facilitation agent 44 may operate under control of the facilitator to be a technical means by which to carry out activities under direction of the facilitator or employees thereof. As such, in some embodiments, the clients 20 may access the SFP platform 10 services, and more particularly contact the facilitation agent 44 online and utilize the services provided thereby. However, it should be appreciated that in other embodiments, an application (e.g., the client application 22) enabling the clients 20 to interact with the facilitation agent 44 (or components thereof) may be provided from the application server 40 (e.g., via download over the network 30) to one or more of the clients 20 to enable recipient clients to instantiate an instance of the client application 22 for local operation such that the facilitation agent 44 may be a distributor of software enabling members or parties to participate in operation of the SFP platform 10. Alternatively, another distributor of the software may provide the client 20 with the client application 22, and the facilitation agent 44 may communicate with the client 20 (via the client application 22) after such download.

In an example embodiment, the client application 22 may therefore include application programming interfaces (APIs) and other web interfaces to enable the client 20 to conduct business via the SFP platform 10. The client application 22 may include a series of control consoles or web pages including a landing page, onboarding services, activity feed, account settings (e.g., user profile information), transaction management services, payment management services and the like in cooperation with a service application that may be executed at the facilitation agent 44. Thus, for example, the client application 22 may enable the customer to preset or change monthly loan terms, review monthly statements, request a physical card, turn on or off a virtual or digital card, access or adjust information associated with the customer account, or receive help or other information. Other useful information and other useful tools for managing the finances of the customer may also be available via the client application 22 in some cases.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the facilitation agent 44 configured to operate in accordance with an example embodiment of the present invention. In this regard, for example, the facilitation agent 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g., a computer including a user interface) via which individual operators or managers of the entity associated with the facilitation agent may interact with, configure or otherwise maintain the SFP platform 10 and/or the facilitation agent 44.

As such, the environment of FIG. 1 illustrates an example in which provision of content and information associated with the financial industry (e.g., including at least some data provided to/from customers and/or vendors in real-time) may be accomplished by a particular entity (namely the facilitation agent 44 residing at the application server 40). Thus, the facilitation agent 44 may be configured to handle provision of content and information associated with tasks that are associated only with the SFP platform 10. Access to the facilitation agent 44 may therefore be secured as appropriate for the individuals or organizations involved and credentials of individuals or organizations attempting to utilize the tools provided herein may be managed by digital rights management services or other authentication and security services or protocols that are outside the scope of this disclosure.

The SFP platform 10 may also operate in cooperation with a card issuer 50, a vendor agent 60, and a payment processor 80. The facilitation agent 44 may be configured to interact with, or otherwise facilitate interactions between, each of the card issuer 50, the vendor agent 60, and the payment processor 80 in order to carry out example embodiments as described herein. In some cases, the facilitation agent 44 may be the card issuer 50. Thus, each of card issuer 50, the vendor agent 60, and the payment processor 80 should be understood to be a computer, server, smart phone, or other technical component or module associated with a respective party (e.g., a card issuer, a vendor, and a payment service, respectively) that is capable of communication with other parties via the network 30, and under control of or responsive to facilitating communication by the facilitation agent 44.

The card issuer 50 may be a bank or other financial services provider. The card issuer 50 may have a persistent relationship with or be the entity associated with the facilitation agent 44 (e.g., the facilitator). The card issuer 50 may be contracted with or otherwise have a pre-existing relationship with the facilitation agent 44 (and entity associated therewith) that enables the facilitation agent 44 to facilitate transactions on behalf of the customer when certain conditions (agreed upon in advance by the entity associated with the facilitation agent 44 and the card issuer 50) are met associated with a transaction undertaken (or attempted) by the customer via the client 20 and client application 22. For example, the card issuer 50 may be the issuer of the payment card on behalf of the facilitation agent 44 and be responsible for directly paying the merchants and vendors during a transaction initiated by the customer via the payment card.

In an example embodiment, the customer may subscribe or enroll to a service or request a card (e.g., a payment card) from the facilitation agent 44 to enroll the customer as a member of the SFP platform 10. During subscription or enrollment, the customer may be prompted (via the client 20 and client application 22) by the facilitation agent 44 to provide details so that the facilitation agent 44 can determine the customer's spending or purchasing power.

The payment processor 80 may be an agent or service that facilitates the acceptance and/or sending of payments between parties online. Thus, for example, the payment processor 80 may utilize its own software, application programming interfaces (APIs) or the like that define an infrastructure or payment platform to connect businesses or companies to manage their businesses or transactions online.

The vendor agent 60 may change for each respective transaction since different vendors may be involved in different transactions involving the clients 20. In some examples, the card issuer 50 and the payment processor 80 may remain the same entities across all transactions managed by the facilitation agent 44. However, the facilitation agent 44 could use different card issuers in different geographic areas or jurisdictions, and the payment processor 80 may also change on the same bases.

As noted above, the SFP platform 10 may operate to enable the customer associated with a given one of the clients 20 to make a purchase in real time from a vendor associated with the vendor agent 60. In some example embodiments, the client application 22 may be used in connection with setting up the account details that are then used as the basis for managing interactions between the parties shown in FIG. 1 under control of the facilitation agent 44. In this regard, for example, the client application 22 may be used to engage (e.g., via a website and corresponding APIs) with the facilitation agent 44 to set up an account with the facilitation agent 44 for services associated with the SFP platform 10. The facilitation agent 44 may prompt the client 20 to provide account details and may provide terms and conditions (electronically or other communication means) that the customer may accept to establish a user profile and user account with the facilitation agent 44. In some cases, the customer may be provided with a payment card or other physical or virtual implement that can be used to initiate transactions with vendors. As noted above, the card may be issued by the card issuer. The card may be associated with the user account, and may provide identifying information needed to initiate operation of the SFP platform 10 (and the facilitation agent 44) as described herein when the customer uses the card to make a purchase with a vendor. The card may be physically presented for such purpose and magnetic strip, chip or other technologies may be used in connection with initiating the transaction. Otherwise, the card number provided on the card may be unique to the user account, and may be provided to the vendor to initiate the transaction. Finally, as an additional or alternative way to initiate a transaction, the card may be virtual and may exist in a mobile wallet or other smartphone context for initiating transactions online. In such a context, the client application 22 may also or alternatively be the means by which the transaction is initiated or handled. Thus, it should be appreciated that the client application 22 could be used to set up the user account and user profile and/or to conduct individual transactions.

The card issuer may have an agreement or relationship with the entity associated with the facilitation agent 44 that enables the facilitation agent 44 to engage the card issuer to extend funds to a merchant or vendor on behalf of the customer in response to instruction from the facilitation agent. The facilitation agent 44 may therefore coordinate communications and funds transferring between members or parties of the SFP platform 10 to facilitate payment transactions that can be settled later or in ways selected specifically by the customer. In this regard, the customer may approach the vendor (physically or virtually) in order to initiate a transaction. The card (virtual or physical) may be provided for payment, and the corresponding indication of a pending transaction may be communicated (e.g., via the SFP platform 10 by the vendor agent 60 and/or the client 20 via the network 30. The communication and activities that ensue thereafter will now be described greater detail below.

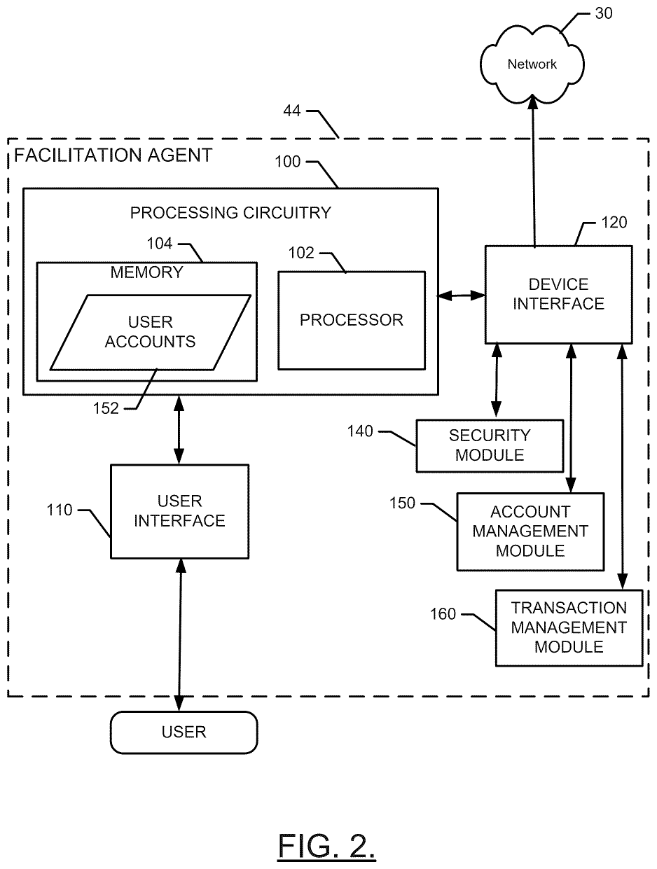

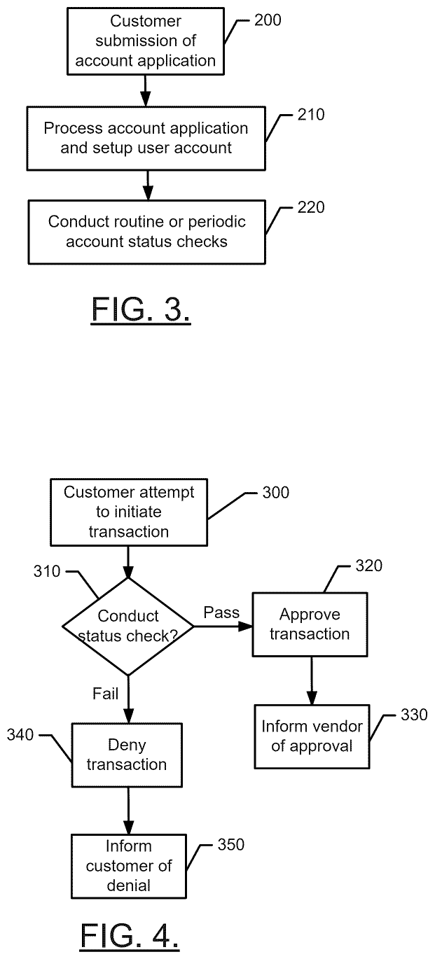

The SFP platform 10 of FIG. 1 may be used before, during and after the time of the transaction in order to enable the facilitation agent 44 to set up the user account, make determinations necessary to initiate the transactions in real time responsive to initiation of the transaction, facilitate enabling the customer to decide how to treat the balance on the payment card (pay in full at the end of the month or convert to an installment loan), and how to settle the transaction. Each of these activities may have its own respective timing and communications that are facilitated by the facilitation agent 44 and FIGS. 3-5 illustrate example control flows associated with each respective scenario. However, prior to examining each respective scenario, the structures associated with an apparatus at which the facilitation agent 44 of an example embodiment may be instantiated will be described in reference to FIG. 2

FIG. 2 shows certain elements of an apparatus for provision of the facilitation agent 44 or other processing circuitry according to an example embodiment. The apparatus of FIG. 2 may be employed, for example, as the facilitation agent 44 itself operating at, for example, a network device, server, proxy, or the like (e.g., the application server 40 of FIG. 1)). Alternatively, embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 40) or by devices in a client/server relationship (e.g., the application server 40 and one or more clients 20). Thus, although FIG. 2 illustrates the facilitation agent 44 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating an exchange for information and services associated therewith in the financial industry is provided. The apparatus may be an embodiment of the facilitation agent 44 or a device of the SFP platform hosting the facilitation agent 44. As such, configuration of the apparatus as described herein may transform the apparatus into the facilitation agent 44. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In situations where the processing circuitry 100 is embodied as a server or at a remotely located computing device, the user interface 110 may be disposed at another device (e.g., at a computer terminal) that may be in communication with the processing circuitry 110 via the device interface 120 and/or a network (e.g., network 30).

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, as indicated above, the user interface 110 may be remotely located.

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 42) that may store a variety of files, contents or data sets. Among the contents of the memory 104, applications (e.g., a service application configured to interface with the client application 22) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the facilitation agent 44, which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 as described below.

The facilitation agent 44 may be configured to include tools to facilitate the creation of customer or user accounts (and a corresponding user profile), and the coordination of communication and fund transfers to support the operations of the SFP platform 10 as described herein. The tools may be provided in the form of various modules that may be instantiated by configuration of the processing circuitry 100. FIG. 2 illustrates some examples of modules that may be included in the facilitation agent 44 and that may be individually configured to perform one or more of the individual tasks or functions generally attributable to the facilitation agent 44 according to an example embodiment. However, the facilitation agent 44 need not necessarily be modular. In cases where the facilitation agent 44 employs modules, the modules may, for example, be configured to perform the tasks and functions described herein. In some embodiments, the facilitation agent 44 and/or any modules comprising the facilitation agent 44 may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 and/or any modules thereof, as described herein.

As shown in FIG. 2, the facilitation agent 44 may include a security module 140. The security module 140 may be configured to enforce data security and data/user access control. In some example embodiments, the security module 140 may employ authentication and authorization tools to manage the provision of access to customers or other SFP platform 10 members or entities wishing to access the SFP platform 10. The security module 140 may operate on queries or communications in real time as such queries or communications are occurring.

The facilitation agent 44 may also include an account management module 150. The account management module 150 may be configured to manage storage of and access to information about individual customers including user accounts 152 and corresponding user profiles, which may include descriptive information about settings, approvals, or management paradigms that apply to specific vendors or transactions for each instance of the user accounts 152.

In an example embodiment, the account management module 150 may handle communications with the clients 20 associated with setting up the user accounts 152. The user profile associated with each respective one of the user accounts 152 may include user preferences, entitlements, or authorizations (e.g., credit limits) with respect to the amount of debt each user is enabled to take on either in aggregate, on a transaction by transaction basis, on a vendor basis, or with respect to specific types of goods or services. Each transaction may, for example, be authorized only if rules associated with either user preferences or policies that the customer has reviewed and accepted as terms of service are met. Those rules may be established during account setup and recorded for each of the user accounts 152 by the account management module 150.

In an example embodiment, the facilitation agent 44 may also include a transaction management module 160. The transaction management module 160 may coordinate or facilitate all communications with the parties to the SFP platform 10 in association with each transaction that is initiated by a customer. As such, the transaction management module 160 may be configured to receive an indication of a pending transaction and, within a predetermined period of time, make a determination as to whether to authorize the transaction or deny the transaction. The decision to authorize or deny the transaction may be made based on either a real time and concurrent check associated with the spending or purchasing power associated with the user account 152. If the account status is satisfactory, the transaction may be authorized, and further communications and coordination details described below may be handled by the transaction management module 160. The transaction management module 160 may also be configured to, assuming certain criteria are met, provide the customer with options for either immediate settlement relative to the transaction, or whether to convert the transaction to a buy now, pay later loan with predetermined (or customer selected) payment terms. The transaction management module 160 may therefore handle communications with the client 20, the vendor agent 60, card issuer 50, and the payment processor 80 as described in greater detail below in response to and after handling a transaction.

FIG. 3 illustrates a block diagram of a communication paradigm that is achievable using an example embodiment for setting up a user account. Referring to FIG. 3, a client (e.g., one of the clients 20 of FIG. 1) may make an account application at operation 200. The account application may be submitted to the facilitation agent 44 via the client application 22 and interface with a website or smart phone application for account setup. The account application may include an identification of the customer (or user) and information establishing a confirmation of employment or monthly income for the customer. The account application may also or alternatively provide account details for the savings account and/or checking account that will serve as the primary account for repayment of funds. The account application may also include permissions, acknowledgements and any other required communications to authorize setup of the user account 152. At operation 210, the facilitation agent 44 may process the account application and setup the user account incorporating a user profile for the user account. As noted above, the user account may include identifying information for the checking or savings account of the customer. At operation 220, the user account may be assigned an initial purchasing or spending power that may be used by user to make purchases via a purchase card and/or installment loan. At operation 230, the facilitation agent may enable the user to pre-set monthly loan terms to act as default terms for loan conversion of any balances carried on the purchase card at the end of every month. As noted above, the account management module 150 may handle the processes of the facilitation agent 44 that are covered by the example of FIG. 3.

FIG. 4 is a block diagram of control flow associated with a customer executing a transaction at the point of sale (or online). As shown in FIG. 2, the initial operation of the customer attempting to initiate a transaction with a vendor may occur at operation 300. The customer may physically present the purchase card, use a digital card, or may provide card number information if the card is not physically present. Thereafter, the facilitation agent 44 may conduct a status check to determine whether to approve or deny the transaction within a predetermined period of time at operation 310. If the status check passes (e.g., indicating that the user's spending or purchasing power is balance sufficient to cover the transaction), the facilitation agent 44 may approve the transaction at operation 320 and the vendor may receive an indication that the transaction has been approved at operation 330. If instead, the status check does not pass (e.g., indicating that the checking or savings account does not have purchasing power sufficient to cover the transaction), then the facilitation agent 44 may deny the transaction and the vendor may receive an indication that the transaction has been denied at operation 340. The customer may also receive (e.g., via the client application 22) a push message to indicate that the transaction was denied at operation 350.

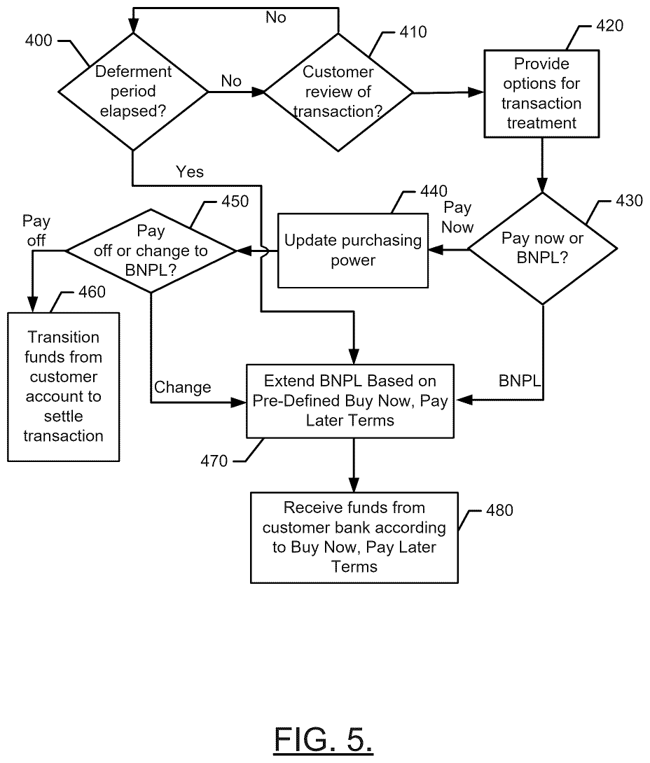

FIG. 5 is a block diagram of control flow associated with intermediate handling of a transaction. In this regard, for some time period after the transaction (e.g., a deferment period), the customer may elect (either proactively or responsive to a prompt from the facilitation agent 44) how to settle the transaction. Otherwise, if no election is made by the expiration of the deferment period, a default election may be assumed. Thus, for example, the customer may (at any time before the expiration of the deferment period (e.g., 48 hours)) utilize the client application 22 to access services of the facilitation agent 44 (e.g., by logging in with appropriate credentials). The customer may recall the transaction (or multiple transactions conducted with the card and associated with the user account 152) via the client application 22 and review details of the transaction (e.g., date, location, vendor, amount, etc.). As an alternative to a customer-initiated recall of the transaction for review, the customer may receive a push message from the facilitation agent 44 requesting the customer to review the transaction (or recent transactions within a given period of time less than the deferment period). Decisions may then be made regarding how to settle the transaction.

In this regard, as shown in FIG. 5, an initial inquiry as to whether the deferment period has expired or elapsed may be conducted at operation 400. If the deferment period has not expired, a determination may be made at operation 410 as to whether customer review of a transaction has been initiated. If not, the process may cycle back to operation 400 until either the deferment period expires or customer review is initiated (either by the customer or by the facilitation agent 44). Whether customer initiated or prompted by the facilitation agent 44, operation 410 may include customer review of a recent transaction (or of recent transactions) that has occurred within the deferment period. If the deferment period is 48 hours, the initiation of customer review at operation 410 may be prompted at 24 hours. However, the customer may initiate such review at any time during the deferment period.

The customer may then be provided (i.e., by the facilitation agent 44) with an option to have the transaction be a “pay now” transaction or convert the transaction to a buy now, pay later transaction at operation 420. It should be understood that “pay now” means that the transaction is counted toward your monthly balance on the purchase card.

In other words, operation 420 may include providing the customer with options for how to treat the transaction. The options in this case may include either treating the transaction as a pay now transaction or treating the transaction as a buy now, pay later transaction at operation 430. In some embodiments, the “pay now” transactions will be create a running balance that is deducted with the user's purchasing power associated with the charge card. This running balance maintenance may be referred to generally as updating purchasing power at operation 440. At the end of the month or payment cycle (i.e., when the deferment period elapses), the user can either pay off the balance in full via the customer's bank account or convert the balance to an installment loan (e.g., BNPL loan) at operation 450. Thus, for the pay off option, funds will be transitioned from the customer's account to the facilitator to settle the corresponding transactions (and adjust the purchasing power accordingly based on remaining account balance information) at operation 460. With respect to the change to installment loan (e.g., BNPL) option, the user has two methods to convert purchases to an installment loan—at the transaction level or on a predetermined (e.g., monthly) basis defined by the deferment period by converting any remaining balance on the purchase card. The facilitation agent 44 may be configured to automatically convert any balance remaining at the end of the cycle (e.g., the end of the deferment period) to an installment loan based on pre-defined terms set by the user or within a predefined window at the end of the cycle. Thus, for example, at operation 470, the facilitation agent 44 may extend buy now, pay later terms to the customer. The terms may indicate a number and periodicity for payments to be withdrawn from the customer's checking or savings account at the customer bank to be paid to the facilitation agent 44. Although not required, in some cases, the customer may be offered and may make an election as to the time period for payments to be made (e.g., 2 weeks, 4 weeks, 6 weeks, etc.) Thereafter, the facilitation agent 44 may receive funds from the customer bank according to the buy now, pay later terms at operation 480 until the balance or transaction is paid in full.

In some embodiments, only transactions of a certain minimum amount (e.g., $100) may be eligible for election to be deferred to a buy now, pay later transaction. However, in some cases, the customer may be enabled to group (e.g., accumulate and combine) a number of smaller transactions to defer payment on the group, and to treat the entire group as a buy now, pay later transaction. The user profile may dictate these options in some cases, or may define limits, minimums or other factors that the facilitation agent 44 may use to determine the terms to offer at operation 470. The limits may include a limit to the amount of buy now, pay later financing that is available to the customer (i.e., how much outstanding loan balance the customer can carry). In an example embodiment, the client application 22 may be used by the customer to review the status of buy now, pay later transactions that are in existence between the customer and the facilitation agent 44.

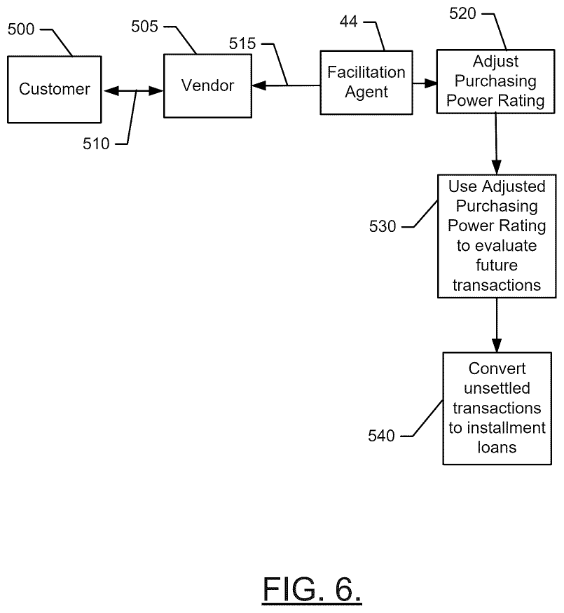

FIG. 6 is a block diagram of control flow associated with flow of funds in accordance with an example embodiment. As shown in FIG. 6, a customer 500 and a vendor 505 may engage in a transaction 510. As an immediate result of the transaction being approved via the processes described above, an authorization 515 for funds to be transferred to the vendor 505 may be issued by facilitator 44, and funds may ultimately be provided. The facilitator 44 may then adjust a purchasing power rating associated with the customer at operation 520. The updated purchasing power rating may thereafter be used in considering future transactions at operation 530. At months end (or otherwise at the end of a payment cycle or deferment period), all non-pay now transactions may automatically be converted into installment loans (e.g., BNPL loans) by the facilitator 44 and another updated purchasing power rating may be calculated at operation 540.

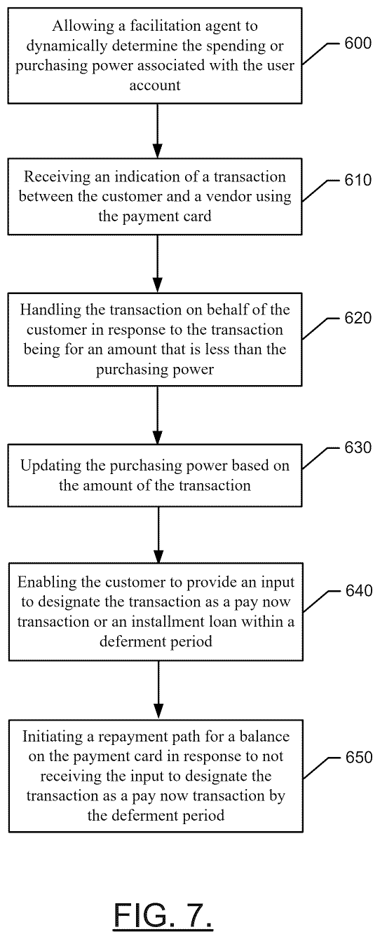

From a technical perspective, the SFP platform 10, and more particularly the facilitation agent 44, described above may be used to support some or all of the operations described above. As such, the apparatus described in FIG. 2 may be used to facilitate the implementation of several computer program and/or network communication based interactions. As an example, FIG. 7 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method of processing a customer transaction according to one embodiment of the invention is shown in FIG. 7. The method may include allowing the facilitation agent 44 to dynamically determine the spending or purchasing power associated with the user account at operation 600. That purchasing power may be accessed via the user through a payment card that can be utilized for pay now transactions. When the user signs up for a payment card associated with their account at the facilitation agent 44, the user has a certain defined purchasing power and any transactions completed with the card may become a balance that is deducted from the purchasing power for the month. Thus, for example, the method may further include receiving an indication of a transaction between the customer and a vendor using the payment card at operation 610 and handling a transaction conducted using the payment card on behalf of the user, if the transaction is for an amount that is lower than the purchasing power at operation 620. The method may also include updating the purchasing power based on the transaction amount at operation 630 (e.g., subtracting the transaction amount from the purchasing power to get an updated purchasing power). In some example embodiments, the transaction may be considered a transaction that is deducted from the purchasing power and accumulates toward a monthly or other predetermined period balance. In some cases, users may also have the option to convert their monthly amount spent or a portion thereof to an installment loan to take advantage of “buy now, pay later” functionality, which may also be deducted from the user's purchasing power but doesn't accumulate toward the balance associated with the purchase card. In accordance with some example embodiments, the conversion of purchases to installment loans may be automated by default in accordance with pre-determined terms at the end of a billing cycle or other predetermined deferment period.

By requesting the payment card, the user may agree to default or pre-set terms that determine how any balance remaining on the purchase card at the end of the month (e.g., the predetermined deferment period) is treated. In this respect and as mentioned above, an individual transaction completed with the purchase card can be a transaction that counts toward the card balance. In some cases, the consumer may have the option to convert individual transactions to an installment loan within a predefined time period, which may be considered to be a deferment period. Thus, for example, the method may further include enabling the customer to provide an input to designate the transaction as a pay now transaction or an installment loan within the deferment period at operation 640. Thereafter, the method may include initiating a repayment path for a balance on the payment card in response to not receiving the input by the deferment period at operation 650.

Any balance carried by the user with respect to the payment card can be repaid in various ways, which may each define a respective one of the repayment paths. In some example embodiments, the repayment paths can include: 1) paying off in full at the end of the billing cycle; 2) default conversion of any remaining balance at the end of the billing cycle to an installment loan based on default terms pre-set by the user; 3) electively converting any remaining balance to an installment loan within a predetermined period at the end of the billing cycle. When the user actively elects to convert the balance to a loan, the conversion to a loan will be underwritten by the facilitation agent and payment options will be offered to the user (which may be different than default terms which may be preselected to take effect in the event of no action by the user). By converting the balance to an installment loan at the end of the billing cycle, this will result in a consolidated loan for all impacted transactions with a consolidated repayment date. With respect to spending or purchasing power available to the consumer, this power will be dynamic based on the user's repayments, creditworthiness, installment loan or payment card balance, among a variety of other factors.

In an example embodiment, an apparatus for performing the method of FIG. 7 above may comprise a processor (e.g., the processor 102) or processing circuitry configured to perform some or each of the operations (600-650) described above. The processor may, for example, be configured to perform the operations (600-650) by performing hardware implemented logical functions, executing stored instructions, or executing algorithms for performing each of the operations. In some embodiments, the processor or processing circuitry may be further configured for additional operations or optional modifications to operations 600 to 650.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, updating the purchasing power may include subtracting the amount of the transaction from the purchasing power to obtain an updated purchasing power. In an example embodiment, in response to receiving an indication of a subsequent transaction, the purchasing power to which an amount of the subsequent transaction may be compared may be considered to be the updated purchasing power. In some cases, handling the transaction may include treating the transaction as a pay now transaction or an installment loan backed transaction based on an input received from the customer, or treating the transaction as a pay now transaction or an installment loan backed transaction based on a default setting in a profile of the customer. In an example embodiment, initiating the repayment path may include converting the transaction to an installment loan in response to expiration of the deferment period. In some cases, converting the transaction to the installment loan may include converting the transaction to the installment loan based on predefined terms agreed by the customer upon obtaining the payment card or based on terms selected by the customer responsive to expiration of the deferment period. In an example embodiment, initiating the repayment path may include obtaining payment in full from the customer by transfer of funds in the amount of the transaction from the user account. In some cases, the method may be repeated a plurality of times for a plurality of transactions, and initiating the repayment path may include initiating the repayment path for a total balance of the plurality of transactions.

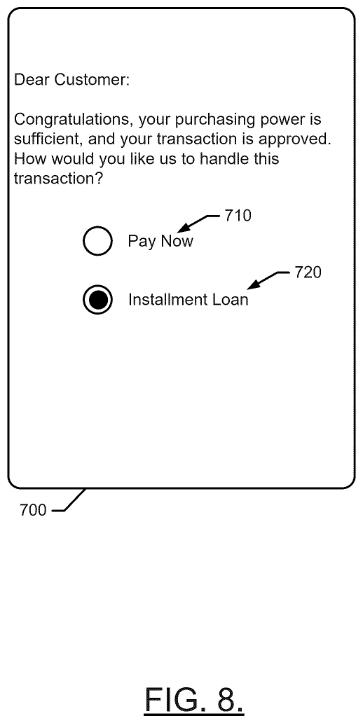

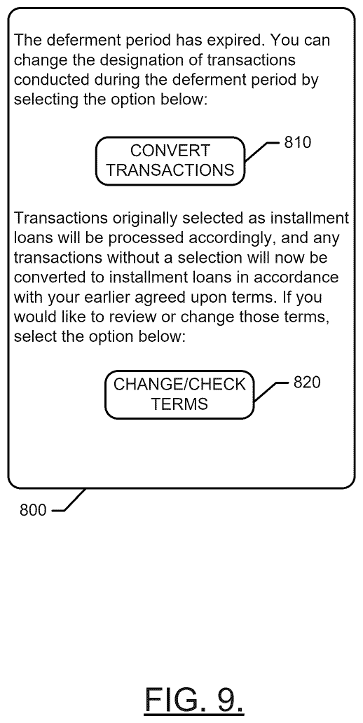

FIG. 8 is an example control console or application interface 700 for selecting how to process a transaction at the time of a transaction in accordance with an example embodiment. This application interface 700 is merely one example of a display screen that may be presented to the customer at operation 430 or operation 620 above. The options may include processing as a pay now transaction 710 or as an installment loan 720. FIG. 9 illustrates an example control console or application interface 800 for either changing how transactions are to be treated (e.g., via convert transactions button 810) or to review and/or change the terms of any installment loan that will be initiated to cover account balances (e.g., change/check terms button 820).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A method of processing a customer transaction associated with a payment card, the method comprising:
determining a purchasing power associated with a user account of the customer;
receiving an indication of a transaction between the customer and a vendor using the payment card;
handling the transaction on behalf of the customer in response to the transaction being for an amount that is less than the purchasing power;
updating the purchasing power based on the amount of the transaction;
enabling the customer to provide an input to designate the transaction as a pay now transaction or an installment loan within a deferment period; and
initiating a repayment path for a balance on the payment card in response to not receiving the input to designate the transaction as a pay now transaction by the deferment period.

2. The method of claim 1, wherein updating the purchasing power comprises subtracting the amount of the transaction from the purchasing power to obtain an updated purchasing power.

3. The method of claim 2, wherein, in response to receiving an indication of a subsequent transaction, the purchasing power to which an amount of the subsequent transaction is compared is the updated purchasing power.

4. The method of claim 1, wherein handling the transaction comprises treating the transaction as a pay now transaction or an installment loan backed transaction based on an input received from the customer.

5. The method of claim 1, wherein handling the transaction comprises treating the transaction as a pay now transaction or an installment loan backed transaction based on a default setting in a profile of the customer.

6. The method of claim 1, wherein initiating the repayment path comprises converting the transaction to an installment loan in response to expiration of the deferment period.

7. The method of claim 6, wherein converting the transaction to the installment loan comprises converting the transaction to the installment loan based on predefined terms agreed by the customer upon obtaining the payment card.

8. The method of claim 6, wherein converting the transaction to the installment loan comprises converting the transaction to the installment loan based on terms selected by the customer responsive to expiration of the deferment period.

9. The method of claim 1, wherein initiating the repayment path comprises obtaining payment in full from the customer by transfer of funds in the amount of the transaction from the user account.

10. The method of claim 1, wherein the method is repeated a plurality of times for a plurality of transactions, and
wherein initiating the repayment path comprises initiating the repayment path for a total balance of the plurality of transactions.

11. An apparatus for processing a customer transaction, the apparatus comprising processing circuitry configured to perform a method comprising:
determining a purchasing power associated with a user account of the customer;
receiving an indication of a transaction between the customer and a vendor using the payment card;
handling the transaction on behalf of the customer in response to the transaction being for an amount that is less than the purchasing power;
updating the purchasing power based on the amount of the transaction;
enabling the customer to provide an input to designate the transaction as a pay now transaction or an installment loan within a deferment period; and
initiating a repayment path for a balance on the payment card in response to not receiving the input to designate the transaction as a pay now transaction by the deferment period.

12. The apparatus of claim 11, wherein updating the purchasing power comprises subtracting the amount of the transaction from the purchasing power to obtain an updated purchasing power.

13. The apparatus of claim 12, wherein, in response to receiving an indication of a subsequent transaction, the purchasing power to which an amount of the subsequent transaction is compared is the updated purchasing power.

14. The apparatus of claim 11, wherein handling the transaction comprises treating the transaction as a pay now transaction or an installment loan backed transaction based on an input received from the customer.

15. The apparatus of claim 11, wherein handling the transaction comprises treating the transaction as a pay now transaction or an installment loan backed transaction based on a default setting in a profile of the customer.

16. The apparatus of claim 11, wherein initiating the repayment path comprises converting the transaction to an installment loan in response to expiration of the deferment period.

17. The apparatus of claim 16, wherein converting the transaction to the installment loan comprises converting the transaction to the installment loan based on predefined terms agreed by the customer upon obtaining the payment card.

18. The apparatus of claim 16, wherein converting the transaction to the installment loan comprises converting the transaction to the installment loan based on terms selected by the customer responsive to expiration of the deferment period.

19. The apparatus of claim 11, wherein initiating the repayment path comprises obtaining payment in full from the customer by transfer of funds in the amount of the transaction from the user account.

20. The apparatus of claim 11, wherein the method is repeated a plurality of times for a plurality of transactions, and
wherein initiating the repayment path comprises initiating the repayment path for a total balance of the plurality of transactions.
